(19) United States
(12) Patent Application Publication
(10) Pub. No.: US 2020/0182053 A1
(43) Pub. Date: Jun. 11, 2020

(54) Optical Computing Device Having A Redundant Light Source and Optical Train

(71) Applicant: HALLIBURTON ENERGY SERVICES, INC., Houston, TX (US)

(72) Inventors: Robert P. Freese, Pittsbororo, NC (US); Christopher Michael Jones, Houston, TX (US); Michael T. Pelletier, Houston, TX (US); David L. Perkins, The Woodlands, TX (US)

(21) Appl. No.: 16/794,427

(22) Filed: Feb. 19, 2020

Related U.S. Application Data
(62) Division of application No. 14/787,062, filed on Oct. 26, 2015.

(51) Int. Cl. E21B 49/00; G01J 3/36; E21B 49/08; E21B 47/10; E21B 47/00; G01V 8/22

(52) U.S. Cl. CPC E21B 49/00; G01J 3/36; G01V 8/22; E21B 47/102; E21B 47/00; E21B 49/08

(57) ABSTRACT

An optical computing device having a redundant light source and/or a plurality of optical elements (i.e., optical train) in order to simultaneously determine characteristics of a sample in real-time by deriving the characteristic data from the output of the optical elements.

### FIELD OF THE INVENTION

The present invention relates generally to optical computing devices and, more specifically, to an optical computing device having a redundant light source and/or an optical train to detect a plurality of sample characteristics simultaneously.

### BACKGROUND

In recent years, optical computing techniques have been developed for applications in the Oil and Gas Industry in the form of optical sensors on downhole or surface equipment to evaluate a variety of fluid properties. An optical computing device is a device configured to receive an input of electromagnetic radiation from a substance or sample of the substance and produce an output of electromagnetic radiation from a processing element, also referred to as an optical element. The optical element may be, for example, a narrow band optical element or an Integrated Computational Element (“ICE”) (also known as a Multivariate Optical Element (“MOE”).

Fundamentally, optical computing devices utilize optical elements to perform calculations, as opposed to the hardwired circuits of conventional electronic processors. When light from a light source interacts with a substance, unique physical and chemical information about the substance is encoded in the electromagnetic radiation that is reflected from, transmitted through, or radiated from the sample. Thus, the optical computing device, through use of the ICE core and one or more detectors, is capable of extracting the information of one or multiple characteristics/properties or analytes within a substance and converting that information into a detectable output signal reflecting the overall properties of a sample. Such characteristics may include, for example, the presence of certain elements, compositions, fluid phases, etc. existing within the substance.

In certain applications, such as downhole permanent placement, there may be limitations in the amount of power available either from battery or a continuous power supply. Also, there may be space requirements that dictate the configuration of the optical computing devices.

Accordingly, there is a need in the art for a robust, compact and power efficient system in which to determine sample characteristics in real-time.

### BRIEF DESCRIPTION OF THE DRAWINGS

FIG. 1 illustrates a well system having optical computing devices deployed therein for sample characteristic detection according to certain exemplary embodiments of the present invention;

FIG. 2A is a block diagram of an optical computing device employing a redundant light source and optical train, according to certain exemplary embodiments of the present invention;

FIG. 2B is a block diagrammatical illustration of an optical computing device utilizing an optical train and multi-element detector, in accordance to an exemplary embodiment of the present invention; and

FIG. 3 is a block diagram of an optical computing device utilizing an optical train and multi-element detector without a redundant light source, according to certain exemplary embodiments of the present invention.

### DESCRIPTION OF ILLUSTRATIVE EMBODIMENTS

Illustrative embodiments and related methodologies of the present invention are described below as they might be employed in an optical computing device and method utilizing a redundant light source and/or an optical train in order to determine one or more characteristics of a sample. In the interest of clarity, not all features of an actual implementation or methodology are described in this specification. Also, the “exemplary” embodiments described herein refer to examples of the present invention. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. Further aspects and advantages of the various embodiments and related methodologies of the invention will become apparent from consideration of the following description and drawings.

As described herein, the present invention is directed to optical computing devices that determine one or more characteristics of a sample. In certain embodiments, the optical computing devices utilize a redundant light source in order to lengthen the useful life of the optical computing device. The light sources are configured and positioned such that they have substantially the same light intensities and divergence. The light sources may be utilized in one at a time or simultaneously. In other exemplary embodiments, a plurality of optical elements (i.e., optical train) are arranged to determine a plurality of characteristics of the sample simultaneously. Such embodiments include various reflective elements which enable the device to utilize all of the electromagnetic radiation emanating from the light sources. Accordingly, the present invention provides a more robust and efficient optical computing device.

In the most preferred embodiment, the optical computing devices described herein utilize an Integrated Computational Element, or ICE, also referred to as a Multivariate Optical Element (“MOE”), as the optical elements. Alternatively, however, narrow band filters may also be utilized as the optical elements. Nevertheless, as will be understood by those ordinarily skilled in the art having the benefit of this disclosure, an ICE is an optical element configured to receive an input of electromagnetic radiation from a substance or sample of the substance and produce an output of electromagnetic radiation that corresponds to a characteristic of the sample.

Fundamentally, optical computing devices utilize the ICE to perform calculations, as opposed to the hardwired circuits of conventional electronic processors. When electromagnetic radiation interacts with a substance, unique physical and chemical information about the substance is encoded in the electromagnetic radiation that is reflected from, transmitted through, or radiated from the sample. This information is often referred to as the substance's spectral “fingerprint.” The ICE extracts the spectral fingerprint of multiple characteristics or analytes within the substance and, using regression techniques, directly converts that information into a detectable output regarding the overall properties of the sample. That is, through suitable configurations of the exemplary optical computing devices, electromagnetic radiation associated with characteristics or analytes of interest in a substance can be separated from electromagnetic radiation associated with all other components of a sample in order to estimate the sample's properties in real-time or near real-time.

The ICEs are capable of distinguishing electromagnetic radiation related to the characteristic or analyte of interest from electromagnetic radiation related to other components of a sample substance. Each ICE includes a plurality of alternating layers, such as silicon (Si) and SiO₂ (quartz). In general, these layers consist of materials whose index of refraction is high and low, respectively. Other examples might include niobia and niobium, germanium and germania, MgF, SiO, and other high and low index materials as known in the art. The layers may be strategically deposited on an optical substrate (BK-7 optical glass, quartz, sapphire, silicon, polycarbonate, etc., for example). At the opposite end (e.g., opposite the optical substrate), the ICE may include a layer that is generally exposed to the environment of the device or installation. The number of layers and the thickness of each layer are determined from the spectral attributes acquired from a spectroscopic analysis of a characteristic of the sample substance using a conventional spectroscopic instrument.

In some embodiments, the material of each ICE layer can be doped or two or more materials can be combined in a manner to achieve the desired optical characteristic. In addition to solids, the ICE may also contain liquids and/or gases, optionally in combination with solids, in order to produce a desired optical characteristic. In the case of gases and liquids, the ICE can contain a corresponding vessel (not shown) which houses the gases or liquids. Exemplary variations of the ICE may also include holographic optical elements, gratings, piezoelectric, light pipe, digital light pipe (DLP), and/or acousto-optic elements, for example, that can create transmission, reflection, and/or absorptive properties of interest.

The multiple layers exhibit different refractive indices. By properly selecting the materials of the layers and their relative spacing, the ICE may be configured to selectively pass/reflect/refract predetermined fractions of light (i.e., electromagnetic radiation) at different wavelengths. Each wavelength is given a predetermined weighting or loading factor. The thicknesses and spacing of the layers may be determined using a variety of approximation methods from the spectrograph of the character or analyte of interest. These methods may include inverse Fourier transform (IFT) of the optical transmission spectrum and structuring the ICE 100 as the physical representation of the IFT. The approximations convert the IFT into a structure based on known materials with constant refractive indices.

The weightings that the ICE layers apply at each wavelength are set to the regression weightings described with respect to a known equation, or data, or spectral signature. Briefly, the ICE may be configured to perform the dot product of the input light beam into the ICE and a desired loaded regression vector represented by each layer for each wavelength. As a result, the output light intensity of the ICE is related to the characteristic or analyte of interest. The output intensity represents the summation of all of the dot products of the passed wavelengths and corresponding vectors.

Further discussion of the design and operation of ICEs and optical computing devices can be found in, for example, Applied Optics, Vol. 35, pp. 5484-5492 (1996) and Vol. 129, pp. 2876-2893; U.S. Pat. No. 6,198,531, entitled “OPTICAL COMPUTATIONAL SYSTEM,” issued to Myrick et al. on Mar. 6, 2001; U.S. Pat. No. 7,697,141, entitled “IN SITU OPTICAL COMPUTATION FLUID ANALYSIS SYSTEM AND METHOD,” issued to Jones et al. on Apr. 13, 2010; and U.S. Pat. No. 8,049,881, entitled “OPTICAL ANALYSIS SYSTEM AND METHODS FOR OPERATING MULTIVARIATE OPTICAL ELEMENTS IN A NORMAL INCIDENCE ORIENTATION,” issued to Myrick et al. on Nov. 1, 2011, the disclosure of each being hereby incorporated by reference in its entirety.

The optical computing devices described herein may be utilized in a variety of environments. Such environments may include, for example, downhole well or completion applications. Other environments may include those as diverse as those associated with surface and undersea monitoring, satellite or drone surveillance, pipeline monitoring, or even sensors transiting a body cavity such as a digestive tract. Within those environments, the optical computing devices are utilized to detect various compounds or characteristics in order to monitor, in real time, various phenomena occurring within the environment.

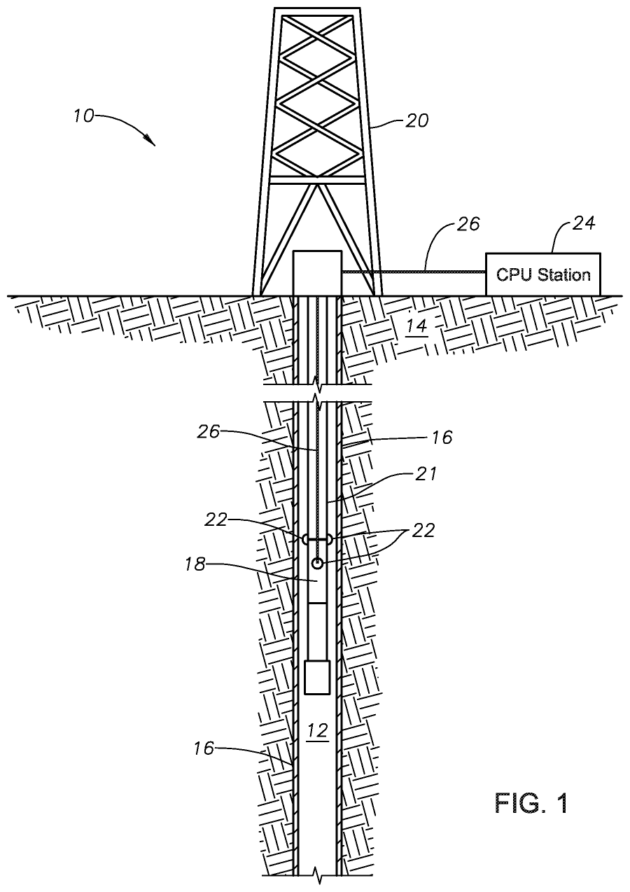

Although the optical computing devices described herein may be utilized in a variety of environments, the following description will focus on downhole well applications. FIG. 1 illustrates a plurality of optical computing devices 22 positioned along a workstring 21 extending along a downhole well system 10 according to certain exemplary embodiments of the present invention. Workstring 21 may be, for example, a logging assembly, production string or drilling assembly. Well system 10 comprises a vertical wellbore 12 extending down into a hydrocarbon formation 14 (although not illustrated, wellbore 12 may also comprise one or more lateral sections). Wellbore equipment 20 is positioned atop vertical wellbore 12, as understood in the art. Wellbore equipment may be, for example, a blow out preventer, derrick, floating platform, etc. As understood in the art, after vertical wellbore 12 is formed, tubulars 16 (casing, for example) are extended therein to complete wellbore 12.

One or more optical computing devices 22 may be positioned along wellbore 12 at any desired location. In certain embodiments, optical computing devices 22 are positioned along the internal or external surfaces of downhole tool 18 (as shown in FIG. 1) which may be, for example, intervention equipment, surveying equipment, or completion equipment including valves, packers, screens, mandrels, gauge mandrels, in addition to casing or tubing tubulars/joints as referenced below. Alternatively, however, optical computing devices 22 may be permanently or removably attached to tubulars 16 and distributed throughout wellbore 12 in any area. Optical computing devices 22 may be coupled to a remote power supply (located on the surface or a power generator positioned downhole along the wellbore, for example), while in other embodiments each optical computing device 22 comprises an on-board battery. Moreover, optical computing devices 22 are communicably coupled to a CPU station 24 via a communications link 26, such as, for example, a wireline, inductive coupling or other suitable communications link. Those ordinarily skilled in the art having the benefit of this disclosure will readily appreciate that the number and location of optical computing devices 22 may be manipulated as desired.

Each optical computing device 22 comprises one or more ICEs that optically interact with a sample of interest (wellbore fluid, downhole tool component, tubular, formation, for example) to determine one or more characteristics of the sample. Such characteristics may be, for example, the presence and quantity of specific inorganic gases such as, for example, CO₂ and H₂S, organic gases such as methane (C1), ethane (C2) and propane (C3) and saline water, in addition to dissolved ions (Ba, Cl, Na, Fe, or Sr, for example) or various other characteristics (p.H., density and specific gravity, viscosity, total dissolved solids, sand content, etc.). Furthermore, the presence of formation characteristic data (porosity, formation chemical composition, etc.) may also be determined. In certain embodiments, a single optical computing device 22 may detect a single characteristic, while in others a single optical computing device 22 may determine multiple characteristics, as will be understood by those ordinarily skilled in the art having the benefit of this disclosure.

CPU station 24 comprises a signal processor (not shown), communications module (not shown) and other circuitry necessary to achieve the objectives of the present invention, as will be understood by those ordinarily skilled in the art having the benefit of this disclosure. In addition, it will also be recognized that the software instructions necessary to carry out the objectives of the present invention may be stored within storage located in CPU station 24 or loaded into that storage from a CD-ROM or other appropriate storage media via wired or wireless methods. Communications link 26 provides a medium of communication between CPU station 24 and optical computing devices 22. Communications link 26 may be a wired link, such as, for example, a wireline or fiber optic cable extending down into vertical wellbore 12. Alternatively, however, communications link 26 may be a wireless link, such as, for example, an electromagnetic device of suitable frequency, or other methods including acoustic communication and like devices.

In certain exemplary embodiments, CPU station 24, via its signal processor, controls operation of each optical computing device 22. In addition to sensing operations, CPU station 24 may also control activation and deactivation of optical computing devices 22. Optical computing devices 22 each include a transmitter and receiver (transceiver, for example) (not shown) that allows bi-directional communication over communications link 26 in real-time. In certain exemplary embodiments, optical computing devices 22 will transmit all or a portion of the characteristic data to CPU station 24 for further analysis. However, in other embodiments, such analysis is completely handled by each optical computing device 22 and the resulting data is then transmitted to CPU station 24 for storage or subsequent analysis. In either embodiment, the processor handling the computations analyzes the characteristic data and, through utilization of Equation of State (“EOS”) or other optical analysis techniques, derives the sample characteristic indicated by the transmitted data, as will be readily understood by those ordinarily skilled in the art having the benefit of this disclosure.

Still referring to the exemplary embodiment of FIG. 1, optical computing devices 22 are positioned along workstring 21 at any desired location. In this example, optical computing devices 22 are positioned along the outer diameter of downhole tool 18. Optical computing devices 22 have a temperature and pressure resistant housing sufficient to withstand the harsh downhole environment. A variety of materials may be utilized for the housing, including, for example, stainless steels and their alloys, titanium and other high strength metals, and even carbon fiber composites and sapphire or diamond structures, as understood in the art. In certain embodiments, optical computing devices 22 are dome-shaped modules (akin to a vehicle dome light) which may be permanently or removably attached to a surface using a suitable method (welding, magnets, etc.). Module housing shapes may vary widely, provided they isolate components from the harsh down-hole environment while still allowing a unidirectional or bidirectional optical (or electromagnetic radiation) pathway from sensor to the sample of interest. As will be understood by those ordinarily skilled in the art having the benefit of this disclosure, dimensions would be determined by the specific application and environmental conditions.

As previously described, optical computing devices 22 may be permanently affixed to the inner diameter of tubular 16 by a welding or other suitable process. However, in yet another embodiment, optical computing devices 22 are removably affixed to the inner diameter of tubulars 16 using magnets or physical structures so that optical computing devices 22 may be periodically removed for service purposes or otherwise. In such embodiments, sample characteristics along various sections of the wellbore may be continually monitored.

As mentioned above, those ordinarily skilled in the art having the benefit of this disclosure realize the optical computing devices described herein may be housed or packaged in a variety of ways. In addition to those described herein, exemplary housings also include those described in Patent Cooperation Treaty Application No. ______, filed on Jun. 20, 2013, entitled “IMPLEMENTATION CONCEPTS AND RELATED METHODS FOR OPTICAL COMPUTING DEVICES, the disclosure of which is hereby incorporated by reference in its entirety.

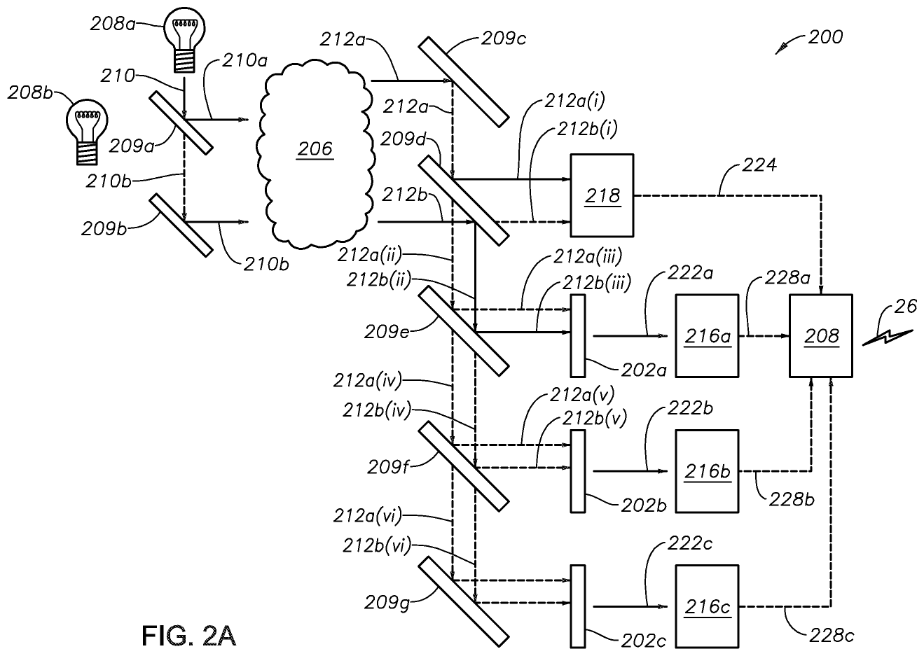

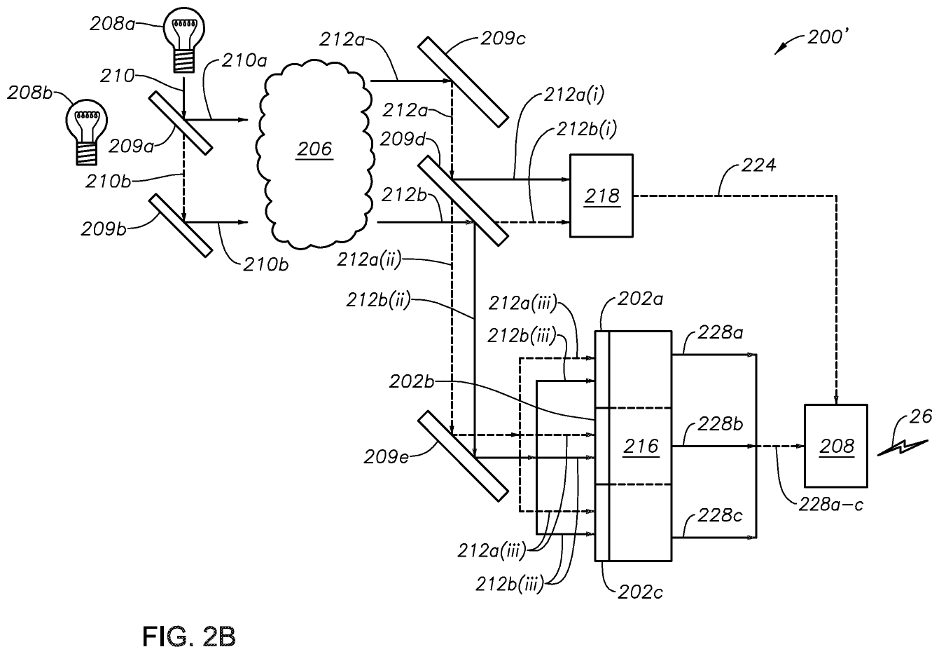

FIG. 2A is a block diagram of an optical computing device 200 employing a redundant light source and optical train, according to certain exemplary embodiments of the present invention. A first and second electromagnetic radiation source 208a and 208b, respectively, is be configured to emit or otherwise generate electromagnetic radiation 210. Electromagnetic radiation sources 208a,b may be operated simultaneously or one at a time. However, for the purpose of simplicity, only electromagnetic radiation source 208a is shown emitting electromagnetic radiation 210. As understood in the art, electromagnetic radiation sources 208a,b may be any device capable of emitting or generating electromagnetic radiation. For example, electromagnetic radiation sources 208a,b may be a light bulb, light emitting device, laser, blackbody, photonic crystal, or X-Ray source, etc. Although not shown, in certain embodiments, electromagnetic radiation sources 208a,b are independent lights sources that are each coupled to the same voltage source so that each has the same or substantially the same light intensities.

A first reflective element 209a is positioned adjacent to electromagnetic radiation sources 208a,b in order to optically interact with electromagnetic radiation 210. First reflective element 209a may be, for example, a beam splitter, mirror or the like which splits electromagnetic radiation 210 into a reflected and transmitted portion. As such, first reflective element 209a reflects a first electromagnetic portion 210a and transmits a second electromagnetic portion 210b toward sample 206. In certain embodiments, first reflective element 209a is configured to equally split electromagnetic radiation 210 into two equal portions (i.e., 50% transmitted/50% reflected), however other split ratios may be utilized as desired.

A second reflective element 209b is positioned adjacent to first reflective element 209a in order to receive the transmitted second electromagnetic portion 210b and then reflect it towards sample 206. Second reflective element 209b may be, for example, a mirror configured to reflect all of second electromagnetic portion 210b. In this exemplary embodiment, electromagnetic is radiation sources 208a,b are positioned at distances from first reflective element 209a such that electromagnetic radiation sources 208a,b have the same or substantially the same light divergence (i.e., the angles of light that are reflected/transmitted by an optical element). As a result, electromagnetic radiation 210a,b have the same intensity and divergence when they interact with sample 206.

In one embodiment, electromagnetic radiation 210a,b is configured to optically interact with the sample 206 (wellbore fluid flowing through wellbore 12 or a portion of the formation 14, for example) and generate corresponding sample-interacted light portions 212a,b directed to a third reflective element 209c (mirror, for example). In this example, sample-interacted light portions 212a,b each represent 50% of the total intensity of electromagnetic radiation 210, as previously described. Sample 206 may be any fluid (liquid or gas), solid substance or material such as, for example, downhole tool components, tubulars, rock formations, slurries, sands, muds, drill cuttings, concrete, other solid surfaces, etc. In other embodiments, however, sample 206 is a multiphase wellbore fluid (comprising oil, gas, water, solids, for example) consisting of a variety of fluid characteristics such as, for example, a C1-C4 or higher hydrocarbon, elemental corrosive by-products, elements generated by sample material loss, C1-C4 and higher hydrocarbons, groupings of such elements, and saline water.

Sample 206 may be provided to optical computing device 200 through a flow pipe or sample cell, for example, containing sample 206, whereby it is introduced to electromagnetic radiation 210a,b. Alternatively, optical computing device 200 may utilize an optical configuration consisting of an internal reflectance element which analyzes the wellbore fluid as it flows thereby or which analyzes the surface of the sample (formation surface, for example). While FIG. 2A shows electromagnetic radiation 210a,b as passing through or incident upon the sample 206 to produce sample-interacted light portions 212a,b (i.e., transmission or fluorescent mode), it is also contemplated herein to reflect electromagnetic radiation 210a,b off of the sample 206 (i.e., reflectance mode), such as in the case of a sample 206 that is translucent, opaque, or solid, and equally generate the sample-interacted light portions 212a,b.

After being illuminated with electromagnetic radiation 210a,b, sample 206 containing an analyte of interest (a characteristic of the sample, for example) produces an output of electromagnetic radiation (first and second sample-interacted light portions 212a,b, respectively, for example). Ultimately, CPU station 24 (or a processor on-board device 200) analyzes this spectral information in order to determine one or more characteristics of sample 206. Although not specifically shown, one or more spectral elements may be employed in optical computing device 200 in order to restrict the optical wavelengths and/or bandwidths of the system and, thereby, eliminate unwanted electromagnetic radiation existing in wavelength regions that have no importance. As will be understood by those ordinarily skilled in the art having the benefit of this disclosure, such spectral elements can be located anywhere along the optical train, but are typically employed directly after the light source which provides the initial electromagnetic radiation.

Still referring to the exemplary embodiment of FIG. 2A, third reflective element 209c is employed to reflect first sample-interacted light portion 212a toward a fourth reflective element 209d (beam splitter, for example). In this example, fourth reflective element 209d is also configured to reflect and transmit 50% of light incident upon it. Fourth reflective element 209d then splits first sample-interacted light portion 212a into a reflected sub-portion 212a(i) and a transmitted sub-portion 212a(ii). At the same time, fourth reflective element 209d also receives second sample-interacted light portion 212b and also splits it into a transmitted sub-portion 212b(i) and a reflected sub-portion 212b(ii). As previously described, first and second sample-interacted light portions 212a,b represent 50% of electromagnetic radiation 210; thus, in this exemplary embodiment, sub-portions 212a(i), 212a(ii), 212b(i) and 212b(ii) each represent 25% of electromagnetic radiation 210.

A fifth reflective element 209e (beam splitter, for example) is then positioned to receive sub-portions 212a(ii) and 212b(ii) and then reflect sub-portions 212a(iii) and 212b(iii) toward optical element 202a. In this example, fifth reflective element 209e is also configured to reflect and transmit 50% of light incident upon it, as previously described. Optical element 202a, as well as the other optical elements of device 200 described below, may be a variety of optical elements such as, for example, one or more narrow band optical filters or ICEs arranged or otherwise used in series in order to determine the characteristics of sample 206. In those embodiments using ICEs, the ICE may be configured to be associated with a particular characteristic of sample 206 or may be designed to approximate or mimic the regression vector of the characteristic in a desired manner, as would be understood by those ordinarily skilled in the art having the benefit of this disclosure. Additionally, in an alternative embodiment, optical element 202a may function as both a beam splitter and computational processor, as will be understood by those same ordinarily skilled persons.

At the same time, fifth reflective element 209e also transmits sub-portions 212a(iv) and 212b(iv) toward a sixth reflective element 209f (50/50 beam splitter, for example). Here, sixth reflective element 209f reflects sub-portions 212a(v) and 212b(v) toward optical element 202b (ICE, for example) whereby they optically interact therewith. Sixth reflective element 209f also transmits sub-portions 212a(vi) and 212b(vi) toward a seventh reflective element 209g. In this example, seventh reflective element 209g (mirror, for example) reflects all of sub-portions 212a(vi) and 212b(vi) toward optical element 202c (ICE, for example). However, in alternative embodiments, any number of optical elements 202 may be utilized in order to determine any desired number of sample characteristics.

Still referring to exemplary FIG. 2A, after the aforementioned sub-portions have been directed toward detector 218 or optical elements 202a-c, optical computing device 200 now determines one or more characteristics of sample 206. Sub-portions 212a(i) and 212b(i) interact with detector 218 which is arranged to receive and detect the sub-portions and output a normalizing signal 224. As understood in the art, electromagnetic sub-portions 212a(i) and 212b(i) may include a variety of radiating deviations stemming from electromagnetic radiation sources 208a,b such as, for example, intensity fluctuations in the electromagnetic radiation, interferent fluctuations (for example, dust or other interferents passing in front of the electromagnetic radiation source), combinations thereof, or the like. Thus, detector 218 detects such radiation deviations as well. Those ordinarily skilled in the art having the benefit of this disclosure will realize there are a variety of design alterations which may be utilized in conjunction with the present invention.

Electromagnetic sub-portions 212a(iii) and 212b(iii) optically interact with optical element 202a to produce optically-interacted light 222a. In this embodiment, optically-interacted light 222a, which is related to a characteristic or analyte of interest, is conveyed to detector 216a for analysis and quantification. Detectors 216a-c may be any device capable of detecting electromagnetic radiation, and may be generally characterized as an optical transducer. For example, detectors 216a-c may be, but is not limited to, a thermal detector such as a thermopile or photoacoustic detector, a semiconductor detector, a piezo-electric detector, charge coupled device detector, video or array detector, split detector, photon detector (such as a photomultiplier tube), photodiodes, and/or combinations thereof, or the like, or other detectors known to those ordinarily skilled in the art. Detector 216a is further configured to produce an output signal 228a in the form of a voltage that corresponds to a particular characteristic of the sample 206. In at least one embodiment, output signal 228a produced by detector 216a and the characteristic data of sample 206 may be directly proportional. In other embodiments, the relationship may be a polynomial function, an exponential function, and/or a logarithmic function.

Electromagnetic sub-portions 212a(v) and 212b(v) optically interacts with optical element 202b in like manner to produce optically-interacted light 222b, and detector 216b then produces a corresponding output signal 228b. Electromagnetic sub-portions 212a(vi) and 212b(vi) also optically interact with optical element 202c in like manner to produce optically-interacted light 222c, and detector 216c then produces a corresponding output signal 228c. In certain exemplary embodiments, each optical element 202a-c is configured to measure a different characteristic of sample 206. For example, optical element 202a may be configured to detect an amount of a C1 hydrocarbon, optical element 202b may be configured to detect an amount of a C2 hydrocarbon, and optical element 202c may be configured to detect an amount of a water content of sample 206. Such detection may be conducted simultaneously or at different time periods.

Detectors 218 and 216a-c, in certain exemplary embodiments, are communicably coupled to a signal processor 208 on-board optical computing device 200 such that normalizing signal 224 indicative of electromagnetic radiating deviations and output signals 228a-c may be provided or otherwise conveyed thereto. The signal processor may then be configured to computationally combine normalizing signal 224 with output signals 228a-c to provide an accurate determination of the characteristics of sample 206. However, in other embodiments that utilized only one detector, the signal processor would be coupled to the one detector. Nevertheless, in the embodiment of FIG. 2A, for example, the signal processor 208 computationally combines normalizing signal 224 with output signals 228a-c. In another embodiment, output signals 228a-c are further combined together via multivariate statistical techniques such as, for example, principal component regression or standard partial least squares, which are available in most statistical analysis software packages (for example, XL Stat for MICROSOFT® EXCEL®; the UNSCRAMBLER® from CAMO Software and MATLAB® from MATHWORKS®), as will be understood by those ordinarily skilled in the art having the benefit of this disclosure. Thereafter, the resulting data is then transmitted to CPU station 24 via communications link 26 for further operations.

As previously described, electromagnetic radiation sources 208a,b may be utilized simultaneously or one at a time. If utilized simultaneously, both radiation sources 208a,b may be operated at a lower voltage than would be used if they were operated independently. In such instances, the amount of radiation interacting with sample 206 would be held constant and the life of the radiation sources would be exponentially longer since a lower operating voltage is utilized. Alternatively, if utilized one at a time, first electromagnetic radiation source 208a may be utilized until it is no longer operational. Thereafter, second electromagnetic radiation source 208b is activated whereby it operates in similar manner to that of first electromagnetic radiation source 208a. For example, second electromagnetic radiation source 208b will emanate electromagnetic radiation 210 whereby first reflective element 209a will split it into a transmitted portion 210a and a reflected portion 210b. Note that such an arrangement is different from the foregoing description in which electromagnetic radiation 210 (emanating from second electromagnetic radiation source 208a) was split by first reflective element 209a into a reflected portion 210a and transmitted portion 210b. Nevertheless, thereafter, portions 210a,b interact with sample 206 and the remaining elements of optical computing device 200 as previously described. Accordingly, through use of the redundant light sources 208a,b, the useful life of optical computing device is prolonged. Moreover, through use of the optical train provided by utilizing a plurality of optical elements configured to detect the same or different sample characteristics, the computational ability of the computing device is increased.

In certain other exemplary embodiments, the aforementioned optical elements may be deposited onto their respective reflective elements using, for example, any known semiconductor wafer fabrication technique (e.g., film layer deposition). In other embodiments, the optical elements may be glued to its respective reflective element. In yet other embodiments, reflective elements 209c-g and optical elements 202a-c may be attached to one another (using adhesive, for example) to thereby form a monolithic piece. In such embodiments, misalignment issues are avoided because temperature fluctuations between the elements will be removed, thus resulting in higher stability of the computing device.

In certain other exemplary embodiments as described herien, the aforementioned optical elements may be deposited onto their respective optical detectors 216a-c using, for example, any known semiconductor wafer fabrication technique (e.g., film layer deposition). In other embodiments, the optical elements may be glued to its respective detector.

In certain other exemplary embodiments, the reflective elements are configured such that a ratio of the reflected electromagnetic portions to the transmitted electromagnetic portions is set to optimize the signal to noise ratio generated by the corresponding detector. Various different ratios may be utilized, such as, for example, 8/92—glass or 30/70). By controlling the ratios, the device optimizes the amount of light for each receiving optical element (202a-c). For example, if element 202a is an element designed to measure asphaltinic content of the oil, and itself has a low average transmission (or low sensitivity), the ratios of fifth reflecting element 209e may be adjusted to allow more light in path 212a(ii) and 212b(ii). This will increase the SNR of signal 228a.

FIG. 2B is a block diagrammatical illustration of a computing device 200′ utilizing an optical train and multi-element detector, in accordance to an exemplary embodiment of the present invention. Here, for example, two or more of detectors 218 and 216a-c may be replaced with a multi-element detector which individually generates corresponding output signals 228. The multi-element detector may be, for example, a split detector, quadrant detector or a one or two dimensional array detector. As shown in FIG. 2B, detectors 216a-b are replaced by a multi-element detector 216 whereby optical elements 202a-c are optically connected to a detector body. As previously mentioned, optical elements 202a-c may be in close proximity to the detector body, deposited thereon, or in contact with the detector body. As electromagnetic sub-portions 212a(iii) and 212b(iii) optically interact with optical elements 202a-c, each optical element generates a respective optically-interacted light corresponding to a different characteristic of sample 206. The optically-interacted light is then measured by multi-element detector 216 which generates corresponding output signals 228a-c as previously described. Through the use of a multi-element detector, the reliability of the computing device is improved because there are less moving/separate parts. Thereafter, optical computing device 200′ operates as described in relation to optical computing device 200.

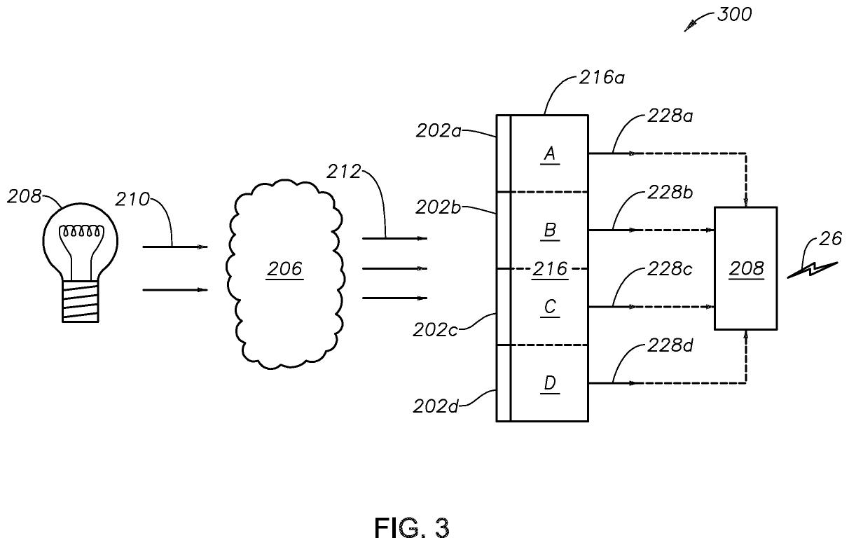

FIG. 3 illustrates a block diagram of yet another optical computing device 300 utilizing an optical train and multi-element detector without a redundant light source, according to certain exemplary embodiments of the present invention. Optical computing device 300 is somewhat similar to optical computing devices 200,200′ described with reference to FIGS. 2A and 2B and, therefore, may be best understood with reference thereto, where like numerals indicate like elements. In this example, however, optical computing device 300 utilizes a single electromagnetic radiation source 208 that generates electromagnetic radiation 210, as well as a multi-element detector 216. Here, multi-element detector 216 is a quadrant detector comprising optical elements 202a-d in optical communication with detector body 216a (having four detector quadrants A,B,C,D associated therewith). Alternatively, however, multi-element detector 216 may be, for example, a split detector or a one or two dimensional array detector.

As previously described, each optical element 202a-d may be configured to be either associated or disassociated with a particular characteristic of the sample 206 contained within sample-interacted light 212. Although four optical elements are described, more or less optical elements may be employed as desired. Additionally, optical elements 202a-d may be in contact with or spaced apart from detector body 216a. Moreover, in certain exemplary embodiments, at least one optical element 202a-d is configured to generate a normalization beam, as understood in the art. Thus, optical elements 202a may be a variety of elements including, for example, a narrow band filter, ICE, open aperture or neutral density element.

After the four quadrants A,B,C,D, of detector body 216a are exposed to its respective optically-interacted light, detector body 216a generates output signals 228a-d which are communicated to signal processor 208, whereby one or more sample characteristics are determined in real-time. Output signals 228a-d may be generated simultaneously or one at a time, for example. In certain embodiments, signal 228a may be a normalization signal, while signals 228b-d correspond to the same or different characteristics of sample 206. For example, signal 228b may correspond to an amount of a C1 hydrocarbon in sample 206, signal 228c corresponds to an amount of a C2 hydrocarbon in sample 206, and signal 228c corresponds to an amount of a C3 hydrocarbon in sample 206.

Those ordinarily skilled in the art having the benefit of this disclosure realize the aforementioned optical computing devices are exemplary in nature, and that there are a variety of other optical configurations which may be utilized. These optical configurations not only include the reflection, absorption or transmission methods described herein, but can also involve scattering (Raleigh & Raman, for example) as well as emission (fluorescence, X-ray excitation, etc., for example). Those ordinarily skilled in the art having the benefit of this disclosure will realize the choice of a specific optical configuration is mainly dependent upon the specific application and analytes of interest.

Accordingly, the present invention provides an optical computing device that determines/monitors sample characteristic data in real-time by deriving the data directly from the output of an optical element. The detected characteristic data may correspond to various elements present in wellbore fluids such as, for example, formation chemistry, sand fraction, porosity, watercut, natural or man-made tags or tracers. Through use of redundant light sources and/or an optical train, the resulting optical computing device is render more robust, efficient and reliable.

An exemplary embodiment provided by the present invention provides an optical computing device to determine a characteristic of a sample, the optical computing device comprising a first electromagnetic radiation source which generates a first electromagnetic radiation; a first reflective element positioned adjacent to the first electromagnetic radiation source to thereby optically interact with the first electromagnetic radiation to reflect a first portion of the first electromagnetic radiation and to transmit a second portion of the first electromagnetic radiation; a second reflective element positioned adjacent to the first reflective element to receive the transmitted second portion of the first electromagnetic radiation and optically interact therewith to reflect the transmitted second portion of the first electromagnetic radiation, wherein the reflected first portion and the transmitted second portion of the first electromagnetic radiation optically interact with a sample to produce sample-interacted light; a first optical element that optically interacts with the sample-interacted light to produce optically-interacted light which corresponds to a first characteristic of the sample; and a detector positioned to measure the optically-interacted light and thereby generate a signal utilized to determine the first characteristic of the sample. Another embodiment further comprises a second electromagnetic radiation source positioned adjacent to the first reflective element, the second electromagnetic radiation source generates a second electromagnetic radiation.

In yet another, the first reflective element is positioned to optically interact with the second electromagnetic radiation to reflect a first portion of the second electromagnetic radiation and to transmit a second portion of the second electromagnetic radiation; the second reflective element is positioned to receive the reflected first portion of the second electromagnetic radiation and optically interact therewith to reflect the reflected first portion of the second electromagnetic radiation; and the reflected first portion and the transmitted second portion of the second electromagnetic radiation optically interacts with the sample to produce sample-interacted light. In another, the first and second electromagnetic radiation sources are positioned at distances from the first reflective element such that the first and second electromagnetic radiation sources have substantially the same divergence. In yet another embodiment, the first and second electromagnetic radiation sources further comprise substantially the same light intensities.

In another embodiment, the optical computing device further comprises a third reflective element positioned to receive a first portion of the sample-interacted light and thereby reflect the first portion of the sample-interacted light; and a fourth reflective element positioned to receive the reflected first portion of the sample-interacted light and a second portion of the sample-interacted light, wherein the fourth reflective element optically interacts with the reflected first portion of the sample-interacted light to thereby reflect a sub-portion of the reflected first portion of the sample-interacted light and to transmit a sub-portion of the reflected first portion of the sample-interacted light, wherein the fourth reflective element further optically interacts with the second portion of the sample-interacted light to thereby reflect a sub-portion of the second portion of the sample-interacted light and to transmit a sub-portion of the second portion of the sample-interacted light. In another, the computing device further comprises a fifth reflective element positioned to receive the transmitted sub-portion of the first portion of the sample-interacted light and the reflected sub-portion of the second portion of the sample-interacted light, to thereby optically interact therewith to reflect the transmitted sub-portion the first portion of the sample-interacted light and the reflected sub-portion of the second portion of the sample-interacted light to the first optical element.

In yet another, the first optical element is an Integrated Computational Element; an Integrated Computational Element in contact with the fifth reflective element; or an Integrated Computational Element deposited onto the fifth reflective element. In another, the fifth reflective element further transmits a portion of the sub-portions of the first and second portions of the sample-interacted light, the device further comprising a sixth reflective element positioned to receive the transmitted portion of the sub-portions of the first and second portions of the sample-interacted light and optically interact therewith to reflect the transmitted portion of the sub-portions of the first and second portions of the sample-interacted light; and a second optical element that optically interacts with the transmitted portion of the sub-portions of the first and second portions of the sample-interacted light to produce optically-interacted light which corresponds to a second characteristic of the sample. In yet another, the first, fourth, fifth and sixth reflective elements are beam splitters, and the second and third reflective elements are optical mirrors.

In another embodiment, the detector is a multi-element detector positioned to measure the optically-interacted light produced by the first and second optical elements and thereby generate signals utilized to determine the first and second characteristics of the sample. In another, the first and second characteristics of the sample are different characteristics of a group comprising a C1-C4 hydrocarbon, water and salt content of the sample. In yet another, the third reflective element, fourth reflective element, fifth reflective element, first optical element, sixth reflective element and the second optical element are physically attached to one another as a single monolithic component. In another, the computing device further comprises a signal processor communicably coupled to the detector to computationally determine the first characteristic of the sample in real-time. In another, the optical computing device comprises at least one of part of a downhole assembly extending along a wellbore; or part of a casing extending along the wellbore. In another, a ratio of the reflected portions and sub-portions to the transmitted portions and sub-portions is set to optimize a signal to noise ratio of the signal generated by the detector.

An exemplary methodology of the present invention provides a method utilizing an optical computing device to determine a characteristic of a sample, the method comprising optically interacting a first electromagnetic radiation with a first reflective element; reflecting a first portion of the first electromagnetic radiation using the first reflective element; transmitting a second portion of the first electromagnetic radiation through the first reflective element; optically interacting the transmitted second portion of the first electromagnetic radiation with a second reflective element; reflecting the transmitted second portion of the first electromagnetic radiation using the second reflective element; optically interacting the reflected first portion and the transmitted second portion of the first electromagnetic radiation with the sample to produce sample-interacted light; optically interacting the sample-interacted light with a first optical element to produce optically-interacted light; generating a first signal that corresponds to the optically-interacted light through utilization of a detector; and determining a first characteristic of the sample using the first signal.

Another method further comprises generating a second electromagnetic radiation; optically interacting the second electromagnetic radiation with the first reflective element; reflecting a first portion of the second electromagnetic radiation using the first reflective element; transmitting a second portion of the second electromagnetic radiation through the first reflective element; optically interacting the reflected first portion of the second electromagnetic radiation with a second reflective element; reflecting the reflected first portion of the second electromagnetic radiation using the second reflective element; optically interacting the reflected first portion and the transmitted second portion of the second electromagnetic radiation with the sample to produce sample-interacted light; generating a second signal that corresponds to the optically-interacted light through utilization of the detector; and determining the first characteristic of the sample using the second signal. In another, the first electromagnetic radiation is generated by a first electromagnetic radiation source and the second electromagnetic radiation is generated by a second electromagnetic radiation source, the method further comprising positioning the first and second electromagnetic radiation sources at distances from the first reflective element such that the first and second electromagnetic radiation sources have substantially the same divergence.

Another method further comprises utilizing the second electromagnetic radiation source while the first electromagnetic radiation source is inactive. In another, the first and second electromagnetic radiation sources comprise substantially the same light intensities. Yet another method further comprises reflecting a first portion of the sample-interacted light using a third reflective element; optically interacting the reflected first portion of the sample-interacted light with a fourth reflective element; optically interacting a second portion of the sample-interacted light with the fourth reflective element; reflecting a sub-portion of the reflected first portion of the sample-interacted light using the fourth reflective element; transmitting a sub-portion of the reflected first portion of the sample-interacted light through the fourth reflective element; optically interacting the second portion of the sample-interacted light with the fourth reflective element; reflecting a sub-portion of the second portion of the sample-interacted light using the fourth reflective element; and transmitting a sub-portion of the second portion of the sample-interacted light through the fourth reflective element. In another, the method further comprises reflecting the transmitted sub-portion of the first portion of the sample-interacted light using a fifth reflective element; reflecting the reflected sub-portion of the second portion of the sample-interacted light using the fifth element; and optically interacting the sub-portions of the first and second portions of the sample-interacted light with the first optical element.

In another method, the first optical element is an Integrated Computational Element. In yet another, the fifth reflective element transmits a portion of the sub-portions of the first and second portions of the sample-interacted light, the method further comprising optically interacting the transmitted portions of the sub-portions of the first and second portions of the sample-interacted light with a sixth reflective element; reflecting the transmitted portions of the sub-portions of the first and second portions of the sample-interacted light; optically interacting the transmitted portions of the sub-portions of the first and second portions of the sample-interacted light with a second optical element; and producing optically-interacted light that corresponds to a second characteristic of the sample. Another method further comprises transmitting the optically-interacted light that corresponds to the first and second characteristics of the sample to the detector; and generating signals utilized to determine the first and second characteristics of the sample.

In another, the first and second characteristics of the sample are different characteristics of a group comprising a C1-C4 hydrocarbon, water and salt content of the sample. In yet another, the method further comprises deploying the optical computing device as part of a downhole assembly or casing extending along a wellbore. Another method further comprises optimizing a signal to noise ratio of the first signal.

Another exemplary embodiment of the present invention provides an optical computing device to determine a characteristic of a sample, the optical computing device comprising electromagnetic radiation that optically interacts with the sample to produce sample-interacted light; a multi-element detector having a plurality of detector sections; and a plurality of optical elements in optical communication with a corresponding detector section, the optical elements being positioned to optically interact with the sample-interacted light to produce optically-interacted light which corresponds to characteristics of the sample, wherein the detector sections measure the optically-interacted light and thereby generates a signal utilized to determine the characteristics of the sample. In another, the optical elements comprise at least one of an Integrated Computational Element, open aperture, or neutral density element. In yet another, the optically-interacted light produced by each optical element corresponds to a different characteristic from the group comprising a C1-C4 hydrocarbon, water, and salt content of the sample. In another, the detector body comprises a split detector, quadrant detector or a one or two dimensional array detector.

In yet another, the computing device further comprises a signal processor communicably coupled to the multi-element detector to computationally determine the characteristics of the sample in real-time. In another, the optical computing device comprises at least one of part of a downhole assembly extending along a wellbore; or part of a casing extending along the wellbore.

An exemplary methodology of the present invention further comprises a method utilizing an optical computing device to determine a characteristic of a sample, the method comprising optically interacting electromagnetic radiation with a sample to produce sample-interacted light; optically interacting an optical element with the sample-interacted light to generate optically-interacted light which corresponds to a characteristic of the sample; optically interacting the sample-interacted light with a plurality of optical elements in optical communication with a multi-element detector to thereby generate optically-interacted light with corresponds to a plurality of characteristics of the sample; utilizing a plurality of detector sections of the multi-element detector to generate a plurality of signals that correspond to the plurality of characteristics; and determining the plurality of characteristics using the signals. In another, the optical element is at least one of an Integrated Computational Element, open aperture, or neutral density element. In yet another, the optically-interacted light generated by each optical element corresponds to a different characteristic from the group comprising a C1-C4 hydrocarbon, water, and salt content of the sample.

In another, the multi-element detector comprises a split detector, quadrant detector or array detector. In yet another, the multi-element detector generates the plurality of signals simultaneously. In another, determining the plurality of characteristics further comprises computationally determining the characteristics in real-time using a signal processor. In yet another, the method further comprises deploying the optical computing device as part of a downhole assembly or casing extending along a wellbore.

Although various embodiments and methodologies have been shown and described, the invention is not limited to such embodiments and methodologies, and will be understood to include all modifications and variations as would be apparent to one ordinarily skilled in the art. For example, certain features of the exemplary embodiments described herein may be combined as desired. Therefore, it should be understood that the invention is not intended to be limited to the particular forms disclosed. Rather, the intention is to cover all modifications, equivalents and alternatives falling within the spirit and scope of the invention as defined by the appended claims.

1-42. (canceled)

43. A method utilizing an optical computing device to determine one or more characteristics of a sample, the method comprising:
optically interacting electromagnetic radiation with a sample to produce sample-interacted light;
optically interacting an optical element with the sample-interacted light to generate optically-interacted light which corresponds to a characteristic of the sample;
optically interacting the sample-interacted light with a plurality of optical elements in optical communication with a multi-element detector to thereby generate optically-interacted light which corresponds to a plurality of characteristics of the sample;
utilizing a plurality of detector sections of the multi-element detector to generate a plurality of signals that correspond to the plurality of characteristics;
determining the plurality of characteristics using the signals.

44. The optical computing method as defined in claim 43, wherein the optical element is at least one of an Integrated Computational Element, open aperture, or neutral density element.

45. The optical computing method as defined in claim 43, wherein the optically-interacted light generated by each optical element corresponds to a different characteristic from the group comprising a C1-C4 hydrocarbon, water, and salt content of the sample.

46. The optical computing method as defined in claim 43, wherein the multi-element detector comprises a split detector, quadrant detector or array detector.

47. The optical computing method as defined in claim 43, wherein the multi-element detector generates the plurality of signals simultaneously.

48. The optical computing method as defined in claim 43, wherein determining the plurality of characteristics further comprises computationally determining the characteristics in real-time using a signal processor.

49. The optical computing method as defined in claim 43, further comprising deploying the optical computing device as part of a downhole assembly or casing extending along a wellbore.

50. An optical computing device to determine a characteristic of a sample, the optical computing device comprising:
a first electromagnetic radiation source which generates a first electromagnetic radiation;
a first reflective element positioned adjacent to the first electromagnetic radiation source to thereby optically interact with the first electromagnetic radiation to reflect a first portion of the first electromagnetic radiation and to transmit a second portion of the first electromagnetic radiation;
a second reflective element positioned adjacent to the first reflective element to receive the transmitted second portion of the first electromagnetic radiation and optically interact therewith to reflect the transmitted second portion of the first electromagnetic radiation,
wherein the reflected first portion and the transmitted second portion of the first electromagnetic radiation optically interact with a sample to produce sample-interacted light;
a first optical element that optically interacts with the sample-interacted light to produce optically-interacted light which corresponds to a first characteristic of the sample;
a detector positioned to measure the optically-interacted light and thereby generate a signal utilized to determine the first characteristic of the sample;
a third reflective element positioned to receive a first portion of the sample-interacted light and thereby reflect the first portion of the sample-interacted light; and
a fourth reflective element positioned to receive the reflected first portion of the sample-interacted light and a second portion of the sample-interacted light,
wherein the fourth reflective element optically interacts with the reflected first portion of the sample-interacted light to thereby reflect a sub-portion of the reflected first portion of the sample-interacted light and to transmit a sub-portion of the reflected first portion of the sample-interacted light,
wherein the fourth reflective element further optically interacts with the second portion of the sample-interacted light to thereby reflect a sub-portion of the second portion of the sample-interacted light and to transmit a sub-portion of the second portion of the sample-interacted light.

51. An optical computing device as defined in claim 50, further comprising a fifth reflective element positioned to receive the transmitted sub-portion of the first portion of the sample-interacted light and the reflected sub-portion of the second portion of the sample-interacted light, to thereby optically interact therewith to reflect the transmitted sub-portion the first portion of the sample-interacted light and the reflected sub-portion of the second portion of the sample-interacted light to the first optical element.

52. An optical computing device as defined in claim 51, wherein the first optical element is:
an Integrated Computational Element;
an Integrated Computational Element in contact with the fifth reflective element; or
an Integrated Computational Element deposited onto the fifth reflective element.

53. An optical computing device as defined in claim 51, wherein the fifth reflective element further transmits a portion of the sub-portions of the first and second portions of the sample-interacted light, the device further comprising:
a sixth reflective element positioned to receive the transmitted portion of the sub-portions of the first and second portions of the sample-interacted light and optically interact therewith to reflect the transmitted portion of the sub-portions of the first and second portions of the sample-interacted light; and
a second optical element that optically interacts with the transmitted portion of the sub-portions of the first and second portions of the sample-interacted light to produce optically-interacted light which corresponds to a second characteristic of the sample.

54. An optical computing device as defined in claim 53, wherein the first, fourth, fifth and sixth reflective elements are beam splitters, and the second and third reflective elements are optical mirrors.

55. An optical computing device as defined in claim 53, wherein the detector is a multi-element detector positioned to measure the optically-interacted light produced by the first and second optical elements and thereby generate signals utilized to determine the first and second characteristics of the sample.

56. An optical computing device as defined in claim 53, wherein the first and second characteristics of the sample are different characteristics of a group comprising a C1-C4 hydrocarbon, water and salt content of the sample.

57. An optical computing device as defined in claim 53, wherein the third reflective element, fourth reflective element, fifth reflective element, first optical element, sixth reflective element and the second optical element are physically attached to one another as a single monolithic component.

58. An optical computing device as defined in claim 50, further comprising a signal processor communicably coupled to the detector to computationally determine the first characteristic of the sample in real-time.

59. An optical computing device as defined in claim 50, wherein the optical computing device comprises at least one of:
part of a downhole assembly extending along a wellbore; or
part of a casing extending along the wellbore.

60. A method utilizing an optical computing device to determine a characteristic of a sample, the method comprising:
optically interacting a first electromagnetic radiation with a first reflective element;
reflecting a first portion of the first electromagnetic radiation using the first reflective element;
transmitting a second portion of the first electromagnetic radiation through the first reflective element;
optically interacting the transmitted second portion of the first electromagnetic radiation with a second reflective element;
reflecting the transmitted second portion of the first electromagnetic radiation using the second reflective element;
optically interacting the reflected first portion and the transmitted second portion of the first electromagnetic radiation with the sample to produce sample-interacted light;
optically interacting the sample-interacted light with a optical element to produce optically-interacted light;
generating a signal that corresponds to the optically-interacted light through utilization of a detector;
determining a characteristic of the sample using the signal;
reflecting a first portion of the sample-interacted light using a third reflective element;
optically interacting the reflected first portion of the sample-interacted light with a fourth reflective element;
optically interacting a second portion of the sample-interacted light with the fourth reflective element;
reflecting a sub-portion of the reflected first portion of the sample-interacted light using the fourth reflective element;
transmitting a sub-portion of the reflected first portion of the sample-interacted light through the fourth reflective element;
optically interacting the second portion of the sample-interacted light with the fourth reflective element;
reflecting a sub-portion of the second portion of the sample-interacted light using the fourth reflective element; and
transmitting a sub-portion of the second portion of the sample-interacted light through the fourth reflective element.

61. An optical computing method as defined in claim 60, further comprising:
reflecting the transmitted sub-portion of the first portion of the sample-interacted light using a fifth reflective element;
reflecting the reflected sub-portion of the second portion of the sample-interacted light using the fifth element; and
optically interacting the sub-portions of the first and second portions of the sample-interacted light with the first optical element.

62. An optical computing method as defined in claim 60, wherein the first optical element is an Integrated Computational Element.

63. An optical computing method as defined in claim 61, wherein the fifth reflective element transmits a portion of the sub-portions of the first and second portions of the sample-interacted light, the method further comprising:
optically interacting the transmitted portions of the sub-portions of the first and second portions of the sample-interacted light with a sixth reflective element;
reflecting the transmitted portions of the sub-portions of the first and second portions of the sample-interacted light;
optically interacting the transmitted portions of the sub-portions of the first and second portions of the sample-interacted light with a second optical element; and
producing optically-interacted light that corresponds to a second characteristic of the sample.

64. An optical computing method as defined in claim 63, further comprising:
transmitting the optically-interacted light that corresponds to the first and second characteristics of the sample to the detector; and
generating signals utilized to determine the first and second characteristics of the sample.

65. An optical computing method as defined in claim 63, wherein the first and second characteristics of the sample are different characteristics of a group comprising a C1-C4 hydrocarbon, water and salt content of the sample.

66. An optical computing method as defined in claim 60, further comprising deploying the optical computing device as part of a downhole assembly or casing extending along a wellbore.

67. An optical computing method as defined in claim 60, further comprising optimizing a signal to noise ratio of the first signal.

68. An optical computing device to determine one or more characteristics of a sample, the optical computing device comprising:
electromagnetic radiation that optically interacts with the sample to produce sample-interacted light;
a multi-element detector having a plurality of detector sections; and
a plurality of optical elements in optical communication with a corresponding detector section, the optical elements being positioned to optically interact with the sample-interacted light to produce optically-interacted light which corresponds to characteristics of the sample, wherein the detector sections measure the optically-interacted light and thereby generates a signal utilized to determine the characteristics of the sample.

69. An optical computing device as defined in claim 68, wherein the optical elements comprise at least one of an Integrated Computational Element, open aperture, or neutral density element.

70. An optical computing device as defined in claim 68, wherein the optically-interacted light produced by each optical element corresponds to a different characteristic from the group comprising a C1-C4 hydrocarbon, water, and salt content of the sample.

71. An optical computing device as defined in claim 68, wherein the detector body comprises a split detector, quadrant detector or a one or two dimensional array detector.

72. An optical computing device as defined in claim 68, further comprising a signal processor communicably coupled to the multi-element detector to computationally determine the characteristics of the sample in real-time.

73. An optical computing device as defined in claim 68, wherein the optical computing device comprises at least one of:
part of a downhole assembly extending along a wellbore; or
part of a casing extending along the wellbore.
